(19) United States
(12) Patent Application Publication
(10) Pub. No.: US 2011/0025292 A1
(43) Pub. Date: Feb. 3, 2011

(54) METHOD AND APPARATUS FOR PROVIDING POWER CONVERSION WITH PARALLEL FUNCTION

(75) Inventors: Guisong Huang, Shanghai Pudong (CN); Kun Lang, Shanghai Pudong (CN); Yahong Xiong, Shanghai Pudong (CN)

Correspondence Address: DITTHAVONG MORI & STEINER, P.C., 918 Prince Street, Alexandria, VA, 22314, US

(73) Assignee: Delta Electronics Inc., Gueishan Township (TW)

(21) Appl. No.: 12/845,693

(22) Filed: Jul. 28, 2010

Related U.S. Application Data
(60) Provisional application No. 61/229,366, filed on Jul. 29, 2009.

(51) Int. Cl. H02J 4/00

(52) U.S. Cl. 323/318

(57) ABSTRACT

An approach is provided for generating a plurality of output signals by a plurality of power modules in response to the respective temperature signals of said modules. Each of the power modules is arranged in parallel, each being configured to provide power conversion. Temperature signals representing temperatures of the plurality of power modules are shared among the plurality of power modules to attain a temperature balance.

### RELATED APPLICATIONS

This application claims the benefit of the earlier filing date under 35 U.S.C. §119(e) of U.S. Provisional Application Ser. No. 61/229,366 filed Jul. 29, 2009, entitled “A Power Converter with Parallel Function,” the entirety of which is incorporated herein by reference.

### BACKGROUND

Power converter circuitry plays a key role in electronic design applications for effectively converting, controlling and monitoring electrical energy to meet specific design and functional requirements. In general, power conversion circuits are designed to receive an input signal and convert it into an output signal of a different type (e.g., AC to DC) or higher or lower magnitude (e.g., 12V to 6V or vice versa). Common applications include personal computers, servers, telecom systems, mobile phones, automobiles, medical equipment, gaming consoles and industrial equipment, and so on. Multiple power modules can be connected in parallel to accommodate high power load applications. For such applications, various methods are employed to enable the effective sharing of electric current between modules connected in parallel, including for example, natural droop, active current droop and active current sharing techniques.

Despite such approaches to affecting current draw among parallel connected modules, there is still a need to maintain a relative temperature balance between the modules in such applications. This is because when the cooling condition of each module is determined to be different, it is usually the case that one of the modules is in the low speed air flow while the other parallel connected modules are in the high speed air flow. If only the current is attempted to be balanced and maintained, the module with the high speed air flow condition will be cooler while that with the low speed air flow condition will exhibit a higher temperature, thus limiting the power capability of the parallel system given that it will first trigger a temperature limitation. In addition, the life of the module with the higher temperature will decrease dramatically.

### SOME EXAMPLE EMBODIMENTS

Therefore, there is a need for an approach to performing power conversion while accounting for temperature conditions.

According to one embodiment, an apparatus comprises a first power module configured to generate a first output signal in response to a first temperature signal representing temperature of the first power module. The first power module is configured to perform power conversion. The apparatus also comprises a second power module coupled to the first power module in parallel. The second power module is configured to generate a second output signal in response to a second temperature signal representing temperature of the second power module. The second power module is configured to perform power conversion.

According to yet another embodiment, a method comprises receiving an input signal by a plurality of power modules arranged in parallel. Each of the power modules is configured to provide power conversion. The method also comprises generating a plurality of temperature signals representing temperatures of the plurality of power modules. The method also comprises generating a plurality of output signals by the power modules in response to the respective temperature signals. The method further comprises supplying the plurality of output signals to a load.

Still other aspects, features and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIGS. 1A and 1B are, respectively, a block diagram depicting power modules arranged in parallel in which temperature balance is maintained, and a flowchart of an associated process for providing temperature balance during power conversion, according to various embodiments;

FIG. 1C is a graph depicting a temperature balance relationship between power modules arranged in parallel.

FIG. 2 is a diagram depicting power modules configured to provide temperature sensing for affecting power control, according to one embodiment;

FIGS. 3A and 3B are diagrams depicting exemplary temperature sensing circuits for use in connection with a power module, according to various embodiments;

FIG. 4 is a block diagram depicting power modules configured to provide temperature sensing and current sensing as arranged in parallel for maintaining a temperature and current balance between modules, according to one embodiment;

FIG. 5 is a diagram depicting power modules configured to provide temperature sensing and current sensing to a voltage sense and error amplifier circuit for affecting power control, according to one embodiment;

FIG. 6 is a diagram depicting a circuit configured to generate a signal representing the combined sharing of signals from a temperature and current sensor, according to one embodiment;

FIG. 7 is a block diagram depicting power modules configured to provide a temperature sensor, current sensor and a sharing bus, as arranged in parallel for maintaining a temperature and current balance between modules, according to one embodiment;

FIG. 8 is a diagram depicting power modules configured to provide temperature sensing and current sensing to an active sharing circuit for affecting power control, according to one embodiment;

FIG. 9 is a diagram depicting an exemplary circuit arrangement for the interaction of an active sharing circuit and a voltage sensing and error amplifier circuit, according to one embodiment.

### DESCRIPTION OF SOME EMBODIMENTS

Examples of a method and apparatus for enabling effective power conversion while accounting for temperature conditions are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

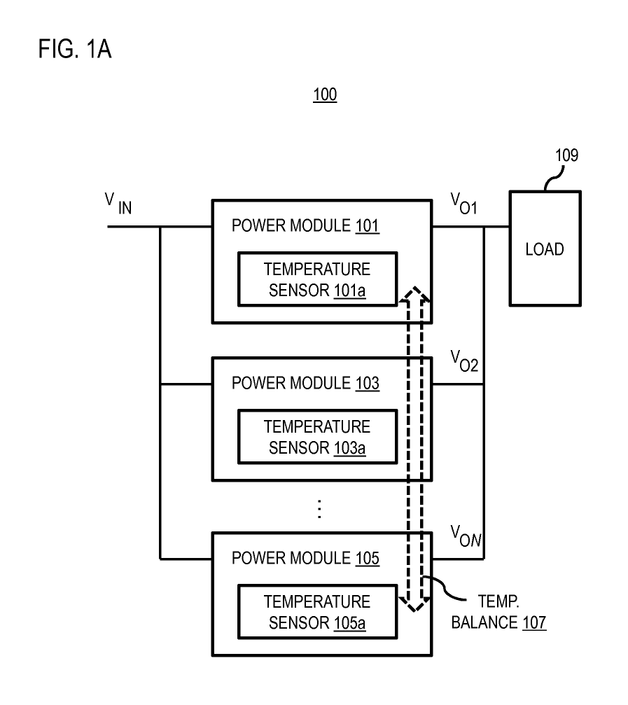

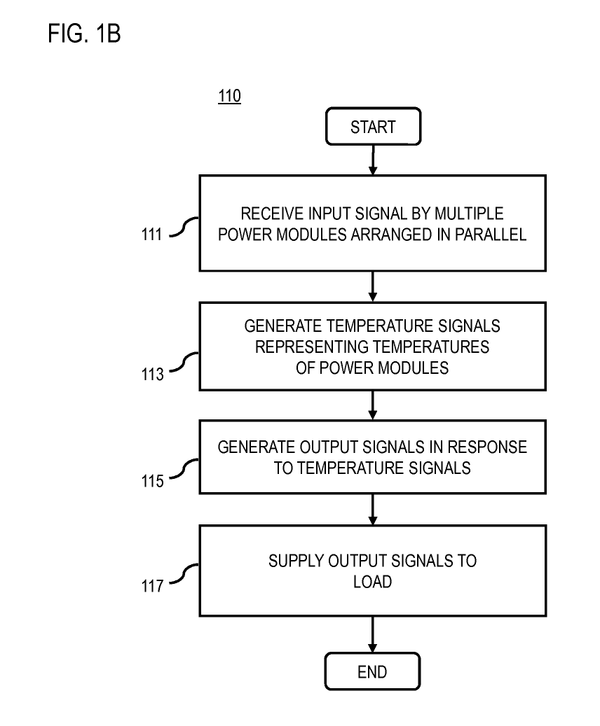

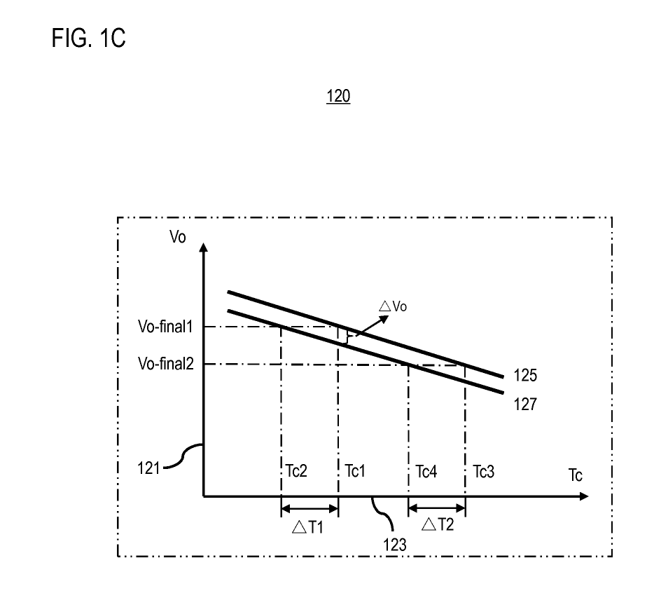

FIG. 1A is a block diagram depicting power modules arranged in parallel in which temperature balance is maintained, according to one embodiment. In multiple power module parallel design implementations, where multiple power modules are coupled to one another to increase the output power capacity of a given system. In this arrangement, the temperature needs to be balanced across each of the parallel power modules without fail to achieve and sustain increased output power gains. To address this concern, an approach is provided to maintain temperature balance in multiple power modules parallel implementations.

Under the scenario of FIG. 1A, power modules 101-105 are configured to provide power conversion of an input voltage V_{IN}, which is supplied to a load 109. The input voltage V_{IN} to each of the power modules 101, 103 and 105 is effectively converted to a respective output voltage V_{O1}, V_{O2} through V_{ON}. Each power module 101-105 also features a respective temperature sensor 101a-105a for detecting a temperature change occurrence within a given power module. The V_{IN} pin and the Vo pin of the modules 101-105, interconnected to one another in accord with a parallel electrical configuration, achieve a temperature balance 107. Under this arrangement, the output voltage of the modules 101-105 are shorted, and hence adjusted during the power conversion process, so as to achieve a desired temperature difference between respective power modules 101-105.

FIG. 1B is a flowchart of the process by which the power modules 101-105 can be coupled in parallel to perform power conversion while maintaining temperature balance, according to one embodiment. In step 111, input signals are received by the multiple power modules 101-105 arranged in a parallel circuitry configuration. Next, in step 113, temperature signals are generated representing the various temperatures of the power modules 101-105—i.e., as detected by respective temperature sensing circuits featuring temperature sensors. In step 115, an output signal is generated in response to the temperature signals. In step 117, the resultant output signals for respective power modules are supplied to load 109.

To better appreciate the above described approach, it is instructive to examine the role of temperature as it relates to power conversion.

FIG. 1C is a graph depicting a temperature balance relationship between parallel coupled power modules, according to one embodiment. As seen, graph 120 shows a negative proportional relationship between the output voltage and temperature values of the respective power modules. In general, there is a declining linear slope relationship between the output voltage value Vo represented by the y-axis 121, and the temperature value Tc represented by the x-axis 123; such that a persistent increase in temperature values results in reduced output voltage levels, while decreased temperature corresponds to an increase in output voltage levels. Line 125 and line 127 represent the Vo vs. Tc curve of two independent operating power modules before they are coupled in parallel; the graph showing that the Vo vs. Tc curve of different power modules do not coincide due to respective component tolerances. Line 125 represents the linear relationship between V_{O} and Tc of a power module which has a higher output voltage at a specific temperature. Line 127 represents the linear relationship between V_{O} and Tc of a power module, which has a lower output voltage at the same specific temperature. By way of example, it is assumed that the slope of the Vo vs. Tc curve of both the power modules is the same and taken as k=dVo/dTc, and the Vo difference of the two module is ΔVo.

When the power modules are configured in parallel and turned on at a specific ambient temperature, the output voltage of each power module will be the same since the output pins are shorted, as represented by Vo−final1. The parallel power modules run into a temperature balance state such that the temperature difference of the parallel modules ΔT1=Tc1−Tc2=ΔVo/k. As with the power modules operating continuously, the power loss of the parallel modules results in the temperature rising; and the output voltage of the parallel modules decreases and remains steady at Vo−fina12. It is noted nonetheless that the temperature difference between the parallel power modules will be kept at ΔT2=Tc3−Tc4=ΔVo/k.

When reliability is considered for practical application purposes, the temperature difference ΔT2=Tc3−Tc4 needs to be as low as possible. The larger the voltage slope k, the smaller the temperature difference ΔT2. However, larger voltage slope k indicates the larger output voltage range. The voltage slope k should be traded off between temperature balance and output voltage range. To keep the Vo difference of the two modules before they are coupled in parallel, ΔVo is maintained as small as possible to achieve better performance for both the temperature balance and limited output voltage range.

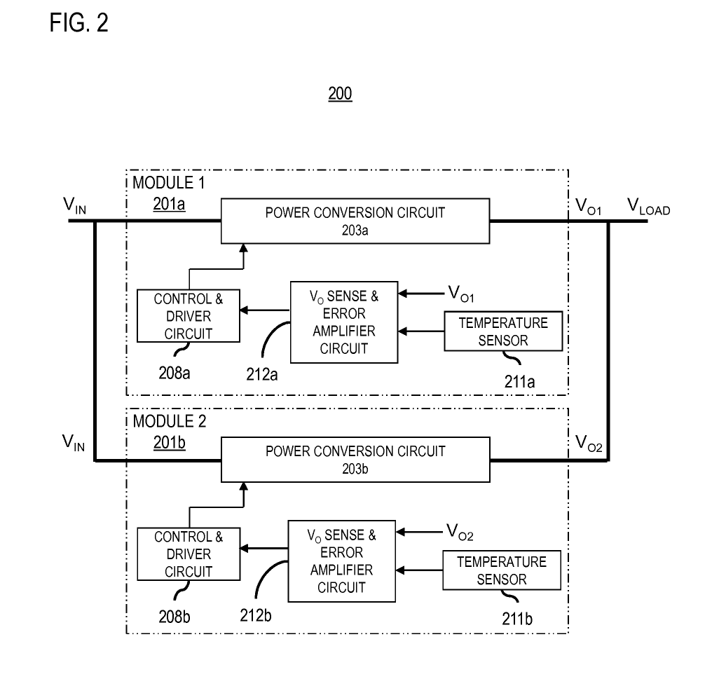

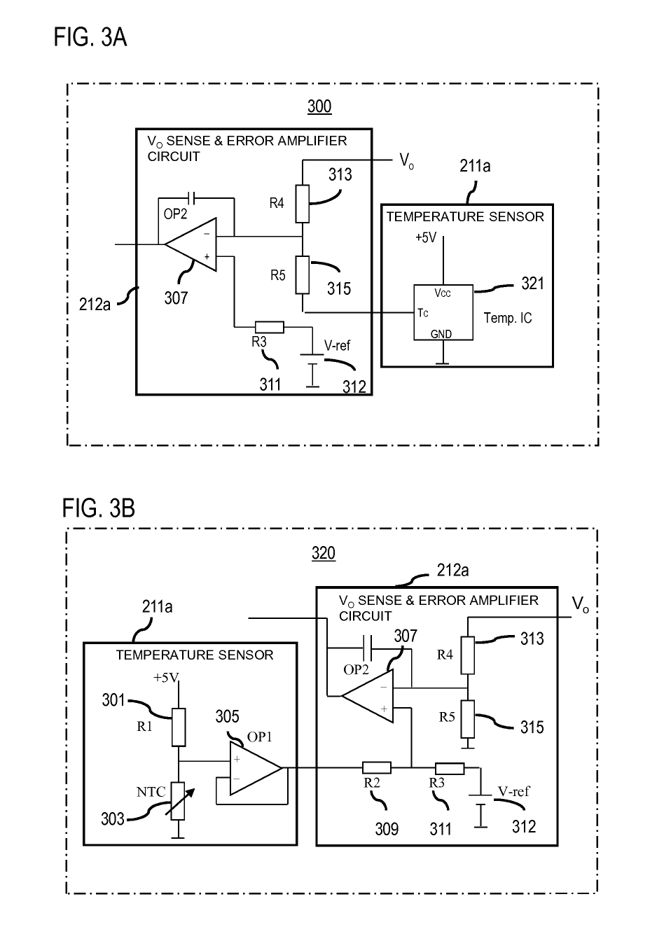

The above relationship is exploited in the arrangements of power modules of FIGS. 2 and 3.

FIG. 2 is a diagram depicting power modules configured to provide temperature sensing for affecting power control, according to one embodiment. In particular, the temperature sensing is provided to the Vo sense and error amplifier circuit 212 as shown. For the purposes of illustration, two power modules 201 are described; however, it is contemplated that the temperature balancing mechanism can be utilized in topologies of any number of modules (i.e., greater than two modules). It is noted that power modules 201a and 201b, which are arranged in parallel, have the capacity to provide double output power to a given load. According to one embodiment, the first power module 201a includes a power conversion circuit 203a, coupled with a Vo sense and error amplifier circuit 212a whose output is connected to a CONTROL and Driver Circuit 208a to regulate the output voltage of the power conversion circuit 203a. An added temperature sensing 211a is connect to Vo sense and error amplifier circuit 212a to participate the adjusting of the Vo set point.

The power conversion circuit 203a, which can be a switching mode power conversion circuit, is comprised of various low loss components (such as switches, capacitors, inductors, and transformers). In particular, the switching mode power conversion circuit employs various switches (which are maintained in either on or off state), to regulate power flow. The switches advantageously dissipate very little power in either the on or off state, enabling power conversion to be accomplished with minimal power loss and hence, higher efficiency. It is contemplated that other supply types can be employed as well.

During operation, the temperature of the first power module 201a is sensed by a temperature sensor circuit 211a, which can be implemented in various ways (according to various embodiments), including but not limited to a negative temperature coefficient resistor (NTC) or a semiconductor temperature IC (e.g.) based sensing circuit.

In operation, the temperature signal changes the output voltage set point with negative direction, so the output voltage drops with the increase of the temperature. The second power module 201b, to which module 201a is electrically coupled, also features the same configuration and design elements of module 201a.

Generally, there is at least an initial tolerance in output voltage between two modules prior to being coupled in parallel. In this example, module 201a is assumed to possess initially a higher voltage than module 201b. Once the two modules 201a and 201b are in parallel, however, most of the current will be provided by module 201a initially and less for module 201b, resulting in the temperature of module 201a increasing to a higher temperature than that of module 201b. Since the temperature of module 201a is higher than that of module 201b, the output voltage of module 201a will drop more extensively, resulting in a current shift to module 201b. This increased current draw by module 201b will result in a temperature increase of the module 201b, resultantly enabling a temperature balance between module 201a and module 201b. As such, efficient and cost effective manufacturing of converter 200 can be realized.

FIGS. 3A and 3B depict exemplary circuit configuration including the temperature sensing circuits and Vo sense and error amplifier circuit. The circuit comprises various arrangements and electrical combinations of resistors and voltage buffers. In the FIG. 3A, a temperature sensor circuit 211a implemented with a positive temperature coefficient temperature IC semiconductor 321 is shown. The output of the Temperature IC 321 is added with the Vo sense signal by R4 313 and R5 315, which is connected to the negative pin of an operational amplifier (op-amp) OP2 307 served as a Voltage feedback op-amp. The positive pin of OP2 307 is connected to a voltage reference V-ref 312. When the temperature rise, the output voltage of Temp IC 321 will increase, causing the Vo of Power module to decrease to keep the OP2 307 negative pin voltage equal to V-ref 312. The proportion of R4 313 and R5 315 determines the temperature compensation, wherein the larger the ratio of R4 313 to R5 315, the larger the slope of Vo versus the temperature.

In FIG. 3B, a temperature sensor circuit 211a implemented with a NTC is shown. A resistor R1 301 is connected in series with the NTC 303, which converts the temperature signal into voltage signal. OP1 305 is an operational amplifier (op-amp) that served as a voltage buffer for providing a low impedance signal to adjust the voltage reference V-ref 312 in the Vo sense and error amplifier circuit. OP2 307 is the voltage feedback op-amp and R4 313 and R5 315 are output voltage feedback dividers, which are connected to the negative pin of the OP2 307. When the temperature rises, NTC resistance will drop and the output voltage of OP1 305 will drop as well. The positive pin voltage of OP2 307 are then adjusted to low, causing the Vo of the power module to decrease to keep the OP2 307 positive pin voltage equal to it's negative pin voltage. The proportion of R2 309 and R3 311 determines the temperature compensation, wherein the larger the ratio of R3 311 to R2 309, the larger the slope of Vo versus the sensed temperature.

It will be recognized that the concepts and techniques presented herein enable a convenient means of power conversion and control while maintaining a temperature balance between parallel multiple power modules. As a result, power modules may be configured accordingly to generate increased output power capability within the context of a power system without necessarily increasing the control connection between each power unit.

Still further, it should be noted that the temperature sensors can be placed at the hottest point of the module; alternatively, the temperature sharing function can be realized at other locations—e.g., sensors are situated at identical corresponding locations among the parallel modules 101-105. As mentioned, this approach can be readily applied to three or more modules that are electrically coupled in parallel.

To further maximize performance, additional embodiments are presented for enabling the maintenance of both a temperature balance and current balance among the modules in parallel. As such, the current balance helps prevent the modules from running into an overcurrent protection (OCP) state at some transient state—i.e., during the power modules start up state, and the plug in state of the power modules and so on.

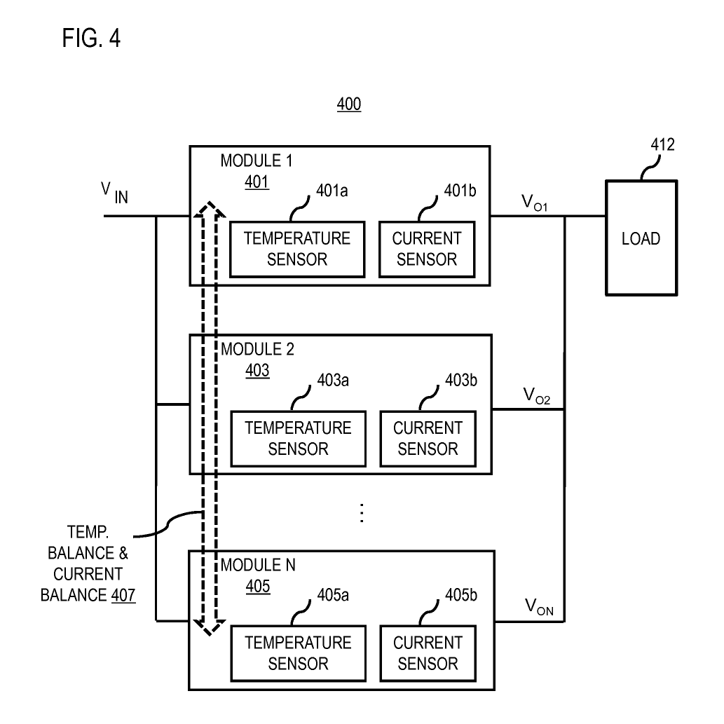

FIG. 4 is a block diagram depicting power modules configured with temperature sensing and current sensing as arranged in parallel for maintaining a temperature and current balance between modules, according to one embodiment. As shown, power modules 401-405 are configured to provide power conversion of an input voltage V_{IN}, which is supplied to a load 412. The input voltage V_{IN} to each of the power modules 401, 403 and 405 is effectively converted to a respective output voltage V_{O1}, V_{O2} through V_{ON}. Each power module 401-405 features a respective temperature sensor 401a-405a for detecting a temperature change occurrence, also features a respective current sensor 401b-405b for detecting a current change occurrence within a given power module. The Vin pin and the Vo pin of the modules 401-405, interconnected to one another in accord with a parallel electrical configuration, achieve a temperature balance and current balance 407. Under this arrangement, the output voltage of the modules 401-405 are shorted and be adjusted during the power conversion process, so as to achieve a desired temperature and current difference between the power modules 401-405.

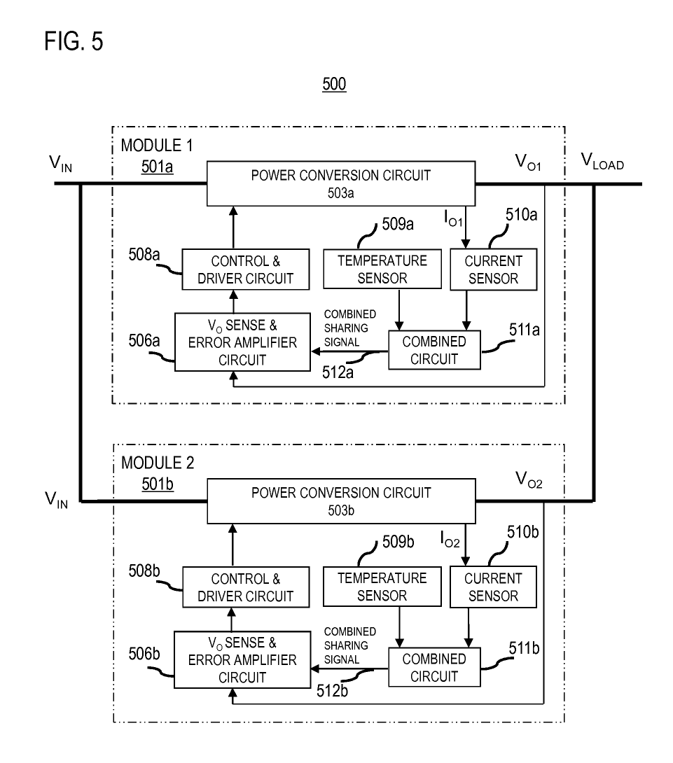

FIG. 5 is a diagram depicting power modules configured to provide temperature sensing and current sensing to the Vo sense & error amplifier circuit for affecting power control, according to one embodiment. For the purposes of illustration, two power modules 501 are described. However, it is contemplated that the temperature and current balance mechanism can be utilized in topologies of any number of modules (i.e., greater than two modules). It is also noted that power modules 501a and 501b, which are arranged in parallel, have the capacity to provide double output power to a given load. The first power module 501a can include a power conversion circuit 503a, coupled with a Vo sense and error amplifier circuit 506a whose output is connected to a control and driver circuit 508a. The control and driver circuit 508a is employed to regulate the output voltage of the power conversion circuit 503a, while an added temperature sensor 509a and an added current sensor 510a are coupled to a combined circuit 511a to output a combined sharing signal 512a. The combined sharing signal is connected to the Vo sense and error amplifier circuit 506a to participate in the adjusting of the Vo set point. The exemplary configuration as shown herein can exhibit substantially the same behavior and current sharing effect as an active current droop power module with a negative temperature coefficient. In this example, the negative temperature coefficient can be set by adjusting the circuit parameters. Generally, there is at least an initial tolerance in output voltage between two modules prior to be parallel. In this example, module 501a is assumed to possess initially a higher voltage than module 501b. Once the two modules 501a and 501b be parallel, most of the current will be provided by module 501a initially and less for module 501b, resulting in the temperature of module 501a increasing to a higher temperature than that of module 501b. Since the current and the temperature of module 501a is higher than that of module 501b, the output voltage of module 501a will drop more extensively, resulting in a current shift to module 501b. This increased current draw by module 501b will result in a temperature increase of the module 501b, which brings a temperature and current balance between module 501a and module 501b. As such, efficient and cost effective manufacturing of converter 500 can be realized.

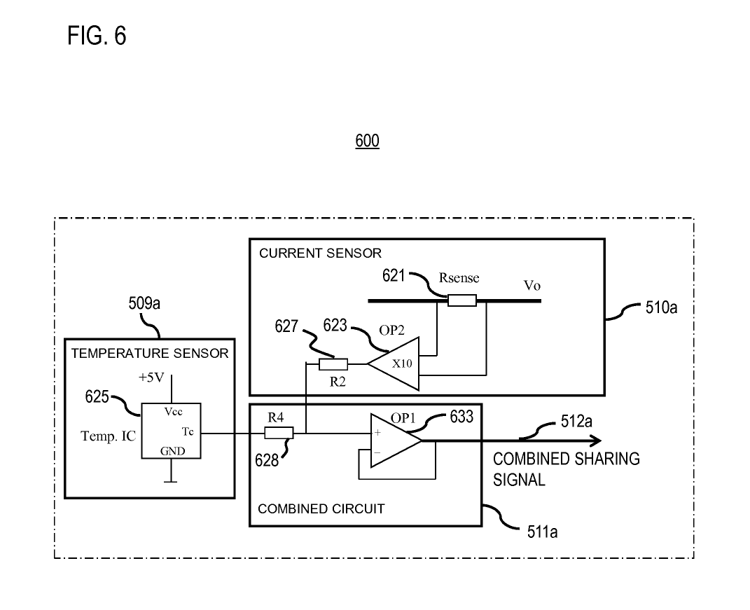

FIG. 6 is a diagram depicting a circuit configured to generate a signal represent the combined sharing of a signal from a temperature sensor and a current sensor, according to one embodiment. In particular, circuit 600 combines the two signals of the temperature and the current sensors 510a and 509a. The current is sensed by Rsense 621 and enlarged by a constant gain of the operational amplifier OP2 623. The sensed current signal is as follows:

Vs(I_{O})=A×I_{O}

The temperature in this case is sensed by the temperature IC 625 whose output voltage is mathematically characterized as follows:

Vs(Tc)=B×Tc

The sensed current signal Vs(Io) and the sensed temperature signal Vs(Tc) is combined by the combined circuit comprised of resistors R4 628, R2 627 and the op-amp OP1 633. The output of the combined circuit is the combined sharing signal, characterized as follows:

Combined Sharing Signal=(Vs(I_{O})×R4+Vs(Tc)×R2)/(R2+R4),

Upon further derivation, the mathematical characterization is as follows:

Combined Sharing Signal=(A×Io×R4+B×Tc×R2)/(R2+R4)

Since R4 628 and R2 627 are constant, for simplicity, the combined sharing signal can be expressed as:

Combined Sharing Signal=KI×Io+KT×Tc,

where KI=A×R4/(R2+R4); KT=B×R2/(R2+R4).

The above derivation shows that the combined sharing signal is proportional with respect to both IO and Tc.

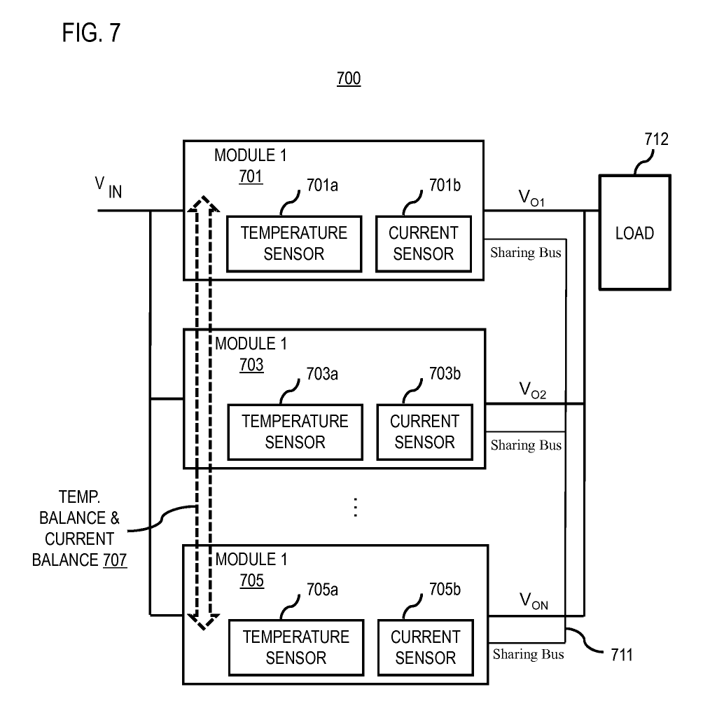

FIG. 7 is a block diagram depicting power modules arranged in parallel in which current and temperature balancing between modules is maintained, according to another embodiment. Converter 700 achieves temperature balance and current balance through use of a temperature sensor, a current sensor and a sharing bus. As shown, power modules 701-705 are configured to provide power conversion of an input voltage V_{IN}, which is supplied to a load 109. The input voltage V_{IN} to each of the power modules 701, 703 and 705 is effectively converted to a respective output voltage V_{O1}, V_{O2} through V_{ON}. Each power module 701-705 features a respective temperature sensor 701a-705a for detecting a temperature change occurrence, a respective current sensor 701b-705b for detecting a current change occurrence, and also a Sharing Bus pin 711 for signal sharing within a given power module. With the exception of the V_{IN} and Vo pin of modules 701-705, which are interconnected to one another in accord with a parallel electrical configuration, the sharing bus pin of modules 701-705 are shorted as well. Under this arrangement, the common sharing bus signal is created, and the output voltage of the modules 701-705 are shorted and adjusted during the power conversion process, so as to achieve a desired temperature and current balance between the power modules 701-705.

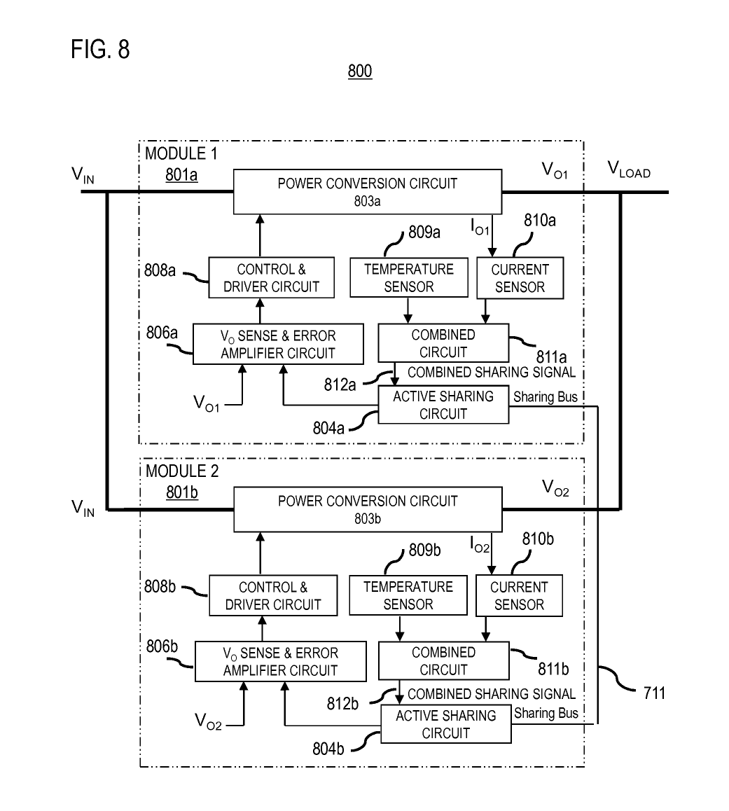

Turning now to FIG. 8, a diagram depicting power modules configured to provide temperature sensing and current sensing to an active sharing circuit for affecting power control, according to one embodiment. It is noted that power modules 801a and 801b, which are arranged in parallel, have the capacity to provide double output power V_{LOAD} to a given load. According to one embodiment, the first power module 801a includes a power conversion circuit 803a, coupled with a Vo sense and error amplifier circuit 806a whose output is connected to a control and driver circuit 808a to regulate the output voltage of the power conversion circuit 803a. In addition, a temperature sensor 809a and a current sensor 810a are added to combined circuit 811a to output a combined sharing signal 812a, also connected to a Active sharing circuit 804a. The active sharing circuit 804a has two outputs: one output is connected to that of the other parallel power module to create the sharing bus 711; the other output is connected to Vo sense and error amplifier circuit 806a to adjust the combined sharing signal 812a of its own power module so that it is equal to the sharing bus 711 signal.

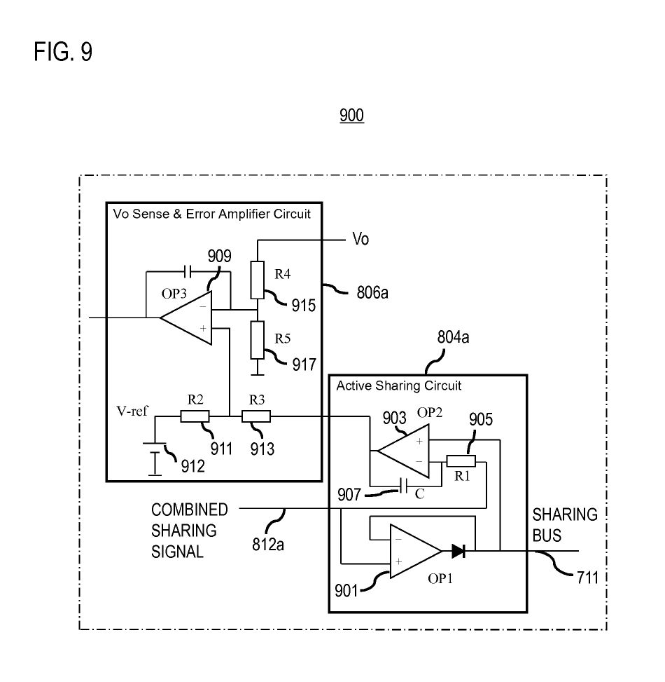

As with module 801a, the second power module 801b includes similar components. The combined sharing signals 812a and 812b from the respective modules 801a and 801b are used to create a sharing bus 711. The active sharing circuit 804a and 804b in each of the corresponding modules 801a and 801b effectively cause the combined sharing signal of each module to be equal with the sharing bus 711. As such, the respective combined sharing signals are equalized with one another, so as to achieve an effective temperature and current balance between interconnected modules 801a and 801b. Circuit 809a, 810a and 811a can employ the same circuit design as depicted with circuit 509a, 510a and 511a. The detailed circuit arrangement is depicted in FIG. 6. FIG. 9 is a diagram depicting an exemplary circuit arrangement for the interaction of an active sharing circuit and a voltage sensing and error amplifier circuit, according to one embodiment.

As shown, in the active sharing circuit block 804a, the combined sharing signal 812a as generated is conducted by operational amplifier OP1 901 to drive the sharing bus 711. Specifically, this refers to the fact that when the sharing bus 711 of multiple power modules are connected together, the highest combined sharing signal between respective modules is allowed to control the sharing bus 711, and the sharing bus signal 711 is equal to the highest combined sharing signal.

The OPA OP2 903 is a sharing error amplifier, which receives the sharing bus signal 711 as the positive input signal, and receives its own combined sharing signal 812a as the negative input signal. The OP2 903 takes the function of error amplifier between its own combined sharing signal 812a with common sharing bus signal 711. Once it is determined that the combined sharing signal 812a is lower than the sharing bus 711, the op-amp OP2 903 will increase it's output signal. Conversely, the op-amp OP2 903 will decrease its output signal.

The Output of OP2 903 is sent to the Vo sense and error amplifier circuit 806a, which is comprised of Vo divider resistors R4 915, R5 917, voltage reference V-ref 912, and voltage error amplifier OP3 909. The output of OP2 903 when summed with V-ref 912 by resistors R3 913 and R2 911 are taken as the positive input signal of OP3 909, which is used to adjust the Vo set point. The increasing of the output signal of OP2 903, is intended to increase the output voltage of the power module which will takes more output current, and increases its own combined sharing signal accordingly. As a feedback result, all combined sharing signals are then equalized with each other.

Unlike traditional approaches, the active sharing circuit as presented herein ensures that the sharing signals comprised of temperature and current equalized each other, and not just for current draw only. When the cooling condition of each module (e.g., modules 701-705 of FIG. 7) is determined to be the same, the relationship between said module's temperature and output current are identical for all modules 701-705. When the cooling condition of each module (e.g., modules 701-705 of FIG. 7) is different, the lower temperature module being able to deliver more current while the higher temperature module delivers less current automatically. By this way, a little current difference is introduced to compensate the temperature difference of the parallel module, a desired temperature balance and current balance are obtained. The total performance of the parallel power modules are thus improved.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. An apparatus comprising:
a first power module configured to generate a first output signal in response to a first temperature signal representing temperature of the first power module, the first power module being configured to perform power conversion; and
a second power module coupled to the first power module in parallel, the second power module being configured to generate a second output signal in response to a second temperature signal representing temperature of the second power module, the second power module being configured to perform power conversion,
wherein the first output signal and the second output signal are provided to a load.

2. An apparatus of claim 1, wherein each of the first power module and the second power module includes a temperature sensor configured to output the first temperature signal and the second temperature signal, respectively.

3. An apparatus of claim 2, wherein the first power module includes an error amplifier circuit, and the first temperature signal is used to change a reference voltage of the error amplifier circuit.

4. An apparatus of claim 2, wherein the first power module includes an error amplifier circuit, and the first temperature signal is used to change an output voltage sensing signal of the error amplifier circuit.

5. An apparatus of claim 2, wherein the first power module includes an error amplifier circuit, and the first temperature signal is used to be one input of the error amplifier circuit

6. An apparatus of claim 3, wherein each of the first power module and the second power module includes:
a current sensor configured to generate a current signal.

7. An apparatus of claim 6, wherein a combiner is configured to combine the current signal with the corresponding one of the temperature signals to produce a sharing signal.

8. An apparatus of claim 6, wherein a shared bus is configured to couple the sharing signals.

9. An apparatus of claim 8, wherein the sharing buses are coupled to permit control by a higher one of the sharing signals.

10. An apparatus of claim 9, wherein each of the sharing signals represents either a sum relationship or a product relationship between the current signal and the temperature signal.

11. An apparatus of claim 2, wherein the temperature sensors are situated at correspondingly identical positions within the respective first power module and the second power module.

12. An apparatus of claim 11, wherein the identical positions correspond to locations with the highest temperature.

13. An apparatus of claim 1, wherein each of the power modules is configured to perform the power conversion using switching mode operation.

14. An apparatus of claim 1, wherein the first output signal is in negative proportion to the first temperature signal, and the second output signal is in negative proportion to the second temperature signal.

15. A method comprising:
receiving an input signal by a plurality of power modules arranged in parallel, each of the power modules being configured to provide power conversion;
generating a plurality of temperature signals representing temperatures of the plurality of power modules;
generating a plurality of output signals by the power modules in response to the respective temperature signals; and
supplying the plurality of output signals to a load.

16. A method of claim 15, wherein each of the power modules includes a temperature sensor configured to output the respective temperature signal.

17. A method of claim 16, wherein each of the power modules includes an error amplifier circuit, and the respective temperature signal is used to change a reference voltage of the error amplifier circuit.

18. A method of claim 16, wherein each of the power modules includes an error amplifier circuit, and the respective temperature signal is used to change an output voltage sensing signal of the an error amplifier circuit.

19. A method of claim 16, wherein each of the power modules includes an error amplifier circuit, and the respective temperature signal is used to be one input of the error amplifier circuit.

20. A method of claim 17, further comprising:
generating, at the corresponding ones of the power modules, a plurality of current signals for controlling the output signal.

21. A method of claim 20, further comprising:
combining the current signals with the respective temperature signals for controlling the output signals.

22. A method of claim 21, further comprising:
producing sharing signals for controlling the output signals by a sharing bus.

23. A method of claim 21, wherein the output signals are based on the highest one of the sharing signals.

24. A method of claim 21, wherein each of the sharing signals represents either a sum relationship or a product relationship between the respective current signal and the respective temperature signal.

25. A method of claim 16, wherein the temperature signals are generated by temperature sensors that are situated at correspondingly identical positions within the respective power modules.

26. A method of claim 25, wherein the identical positions correspond to locations with the highest temperature.

27. A method of claim 15, wherein each of the power modules is configured to perform the power conversion using switching mode operation.

28. A method of claim 15, wherein each of the output signals is in negative proportion to the respective temperature signals.
